(19) United States
(12) Patent Application Publication
(10) Pub. No.: US 2013/0224481 A1
(43) Pub. Date: Aug. 29, 2013

(54) SEAMLESS BELT

(71) Applicants: Ki Nam Kwak, Yongin-si (KR); Jeong Han Kim, Seongnam-si (KR); Ji Sung Kim, Seoul (KR)

(72) Inventors: Ki Nam Kwak, Yongin-si (KR); Jeong Han Kim, Seongnam-si (KR); Ji Sung Kim, Seoul (KR)

(73) Assignee: KOLON INDUSTRIES, INC., Gyeonggi-do (KR)

(21) Appl. No.: 13/877,073

(22) PCT Filed: Sep. 28, 2011
(86) PCT No.: PCT/KR2011/007155

§ 371 Date: Apr. 29, 2013

(30) Foreign Application Priority Data
Sep. 30, 2010 (KR) 10-2010-0095654

(51) Int. Cl. C09D 1/00

(52) U.S. Cl. CPC C09D 1/00
USPC 428/336; 106/287.11; 423/324

(57) ABSTRACT

Disclosed is a belt for an image forming apparatus including a releasing coating layer including a layered inorganic compound.

### TECHNICAL FIELD

The present invention relates to a seamless belt used as an intermediate transfer belt, a fixing belt, or the like for an image forming apparatus.

### BACKGROUND ART

In a belt for an image forming apparatus in the image forming apparatus such as a copier, a facsimile, a printer, and the like, for example, the belt for the image forming apparatus such as an intermediate transfer belt used in a transfer unit, a fixing belt used in a fixing unit, and the like, in general, a cylinder of a resin material made of a polyimide resin and a cylinder of a metal material are used as the fixing belt from the requirement of a high-density driving.

The fixing belt requires heat resistance for a fixing temperature or a releasing property for a toner. As a result, an outer surface (a surface contacting the toner) of the fixing belt is covered by a heat-resistance releasing coating film such as a fluorine resin and the like. The fixing belt requires durability enough to stand against a copy of about one hundred thousand sheets at a speed of 30 to 40 sheets/min. Accordingly, the fixing belt requires a strong adhesion between a substrate layer and a releasing layer.

In general, the fixing belt may acquired by a method of molding and drying a cylinder from a polyimide precursor solution acquired by reacting with tetracarboxylic acid dianhydrides and diamines in a polar polymerization solvent, applying and drying a primer on the cylinder, and then applying and drying a fluorine resin dispersion solution on the primer layer, and finally, imidizating the polyimide precursor at a high temperature and sintering the fluorine resin, or a method of processing a metal material to a cylinder, applying and drying a primer on the cylinder, and then applying, drying, sintering a fluorine resin dispersion solution on the primer layer. As the method of preparing the cylinder from the polyimide precursor solution, for example, a method which acquires the polyimide cylinder by molding the polyimide precursor solution in an outer surface or inner surface of a mold at a predetermined thickness and then, heating or chemically imidizing the molded polyimide precursor solution to separate the polyimide precursor solution from the mold, is proposed.

### DISCLOSURE OF INVENTION

### Technical Problem

However, the fluorine resin which is a main material of the releasing resin layer has a modified temperature of about 280° C. such that there is a limit to what a continue use temperature of the transfer belt or fixing belt including the releasing resin layer is not more than 280° C.

### Solution to Problem

The present invention has been made in an effort to provide a seamless belt including a releasing coating layer having improved heat resistance.

An exemplary embodiment of the present invention provides a seamless belt including a releasing coating layer including a layered inorganic compound represented by the following Chemical Formula 1.

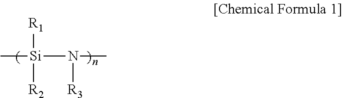

Herein, n is an integer, R₁, R₂, and R₃ are respectively hydrogen atoms or alkyl groups, alkenyl groups, cycloalkyl groups, aryl groups, alkyl silyl groups, alkoxy groups which are C₁-C₁₈, but at least one of R₁, R₂, and R₃ is the hydrogen atom.

The layered inorganic compound may be one or more selected from a group configured by polysilazane, silica, polysiloxane, and derivatives thereof.

The layered inorganic compound may have a molecular weight of 200 to 50000.

The solvent of the releasing coating layer may be formed from a solution including acetone, tetrahydrofuran, dioxane, methylene chloride, chloroform, cyclohexane, cyclohexanone, methylethylketone, n-Hexane, diethylether, dibutylether, ethylacetate, dichloromethane, dichloroethane, pentane, ether, hexane, heptane, octane, and isodecane.

The releasing coating layer may have a thickness of 0.05 to 25 μm.

The releasing coating layer may be formed at the outermost surface.

The seamless belt may have a use as an intermediate transfer belt of an image forming apparatus.

The seamless belt may have a use as a fixing belt of an image forming apparatus.

### BEST MODE FOR CARRYING OUT THE INVENTION

Hereinafter, the present invention will be described below in more detail.

A belt for an image forming apparatus according to an exemplary embodiment of the present invention includes a releasing coating layer including a layered inorganic compound represented by the following Chemical Formula 1.

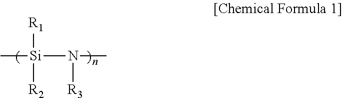

Herein, n is an integer, R₁, R₂, and R₃ are respectively hydrogen atoms or alkyl groups, alkenyl groups, cycloalkyl groups, aryl groups, alkyl silyl groups, alkoxy groups which are C₁-C₁₈, but at least one of R₁, R₂, and R₃ is the hydrogen atom.

A layered inorganic compound solution including the layered inorganic compound represented by Chemical Formula 1 is cured by leaving a seamless belt coated with the layered inorganic compound solution in air and the layered inorganic compound absorbs moisture in air to be cured as an inorganic film. The layered inorganic compound solution may be heated in order to increase the curing speed. The layered inorganic compound expresses adhesion for a substrate in the film formation and a releasing property for a toner when the layered inorganic compound is disposed on an outermost surface of the seamless belt having the releasing property at the same time. Here, the substrate may be a metal material or a polycarbonate or polyimide-based resin and adhesion for each base is substantially the same.

Further, since a continuous using temperature of the seamless belt is 350° C. or more due to the film formed in the curing of the layered inorganic compound, heat resistance and the releasing property are improved.

Considering the improvement in the heat resistance and the releasing property of the seamless belt, a molecular weight of the layered inorganic compound represented by Chemical Formula 1 may be 200 to 50000.

Further, when the molecular weight of the layered inorganic compound represented by Chemical Formula 1 is less than 200, coating uniformity of the surface of the seamless belt is deteriorated and when the molecular weight of the layered inorganic compound coated on the surface of the seamless belt is more than 50000, the polysilazane is not dissolved in a solvent well. In the exemplary embodiment, the coating of the seamless belt surface may be maintained in a uniform state by having the molecular weight of at least 200 or more.

For example, all of polysilazanes and the derivatives thereof of the layered inorganic compound in the exemplary embodiment which are prepared by a known method in the related art are preferable. The method of preparing the polysilazane and derivative thereof may use any method including a known method in the related art. As an example of the method, for example, a synthesis method by reacting with an adduct of dihalosilane and ammonia after forming the adduct of dihalosilane by reacting with dihalosilane of Chemical Formula SiH₂X₂ (herein, X is a halogen atom) and a base may be used. In general, halosilane is an acidity and the adduct may be formed by reacting with halosilane and a base. Since a forming speed of the adduct and stability as the adduct depend on acidic intensity, basic intensity of a basic material, a steric factor, and the like, the adduct, which is stable by selecting appropriately a kind of halosilane and a kind of the base and capable of preparing easily the polysilazane and derivative thereof by reaction with ammonia, may be formed. In this case, stability of the adduct does not mean the stability enough to isolate the adduct and includes the case stably included in the solvent and all the cases substantially used as a reaction intermediate.

As halosilane, dihalosilane of Chemical Formula of SiH₂X₂ is preferably used selected in view of handability and reactivity and particularly, dichlorosilane is preferably used in view of the reactivity, the price of raw materials, and the like.

It is preferred if the base used for forming the adduct is a base which does not cause a reaction other than the reaction forming the adduct with halosilane and for example, the base may use tertiary amines (trialkylamine), pytidine, and a derivative thereof; secondary amines, phosphine, arsine, and a derivative thereof, and the like and particularly, pyridine is preferably used in view of handability and economic efficiency. An amount of the used base is not particularly limited and it is sufficient if the amount of the base is larger than a stoichiometric amount for silane including amine in the adduct, that is, amine:silane=2:1. Further, the adduct formation reaction occurs in the solvent.

Accordingly, the releasing coating layer may be configured by only one component selected from the layered inorganic compounds and may be a mixture of two or more. The two or more layered inorganic compounds make a slight difference in a chemical structure and a component, but are similar in the releasing property, an antifouling property, and heat resistance.

In general, other components configuring the releasing coating layer may further be included.

In this case, the content of the component represented by the Chemical Formula 1 in the releasing coating layer is at least 50 to 100 wt % with respect to a weight of the releasing coating layer, preferably 70 to 95 wt % in view of the releasing property, the antifouling property, heat resistance, and a surface characteristic.

Examples of other components configuring the releasing coating layer may be known additives, for example, a filler, a dye, a pigment, a pigment dispersion, a solid lubricant, a sedimentation inhibitor, a leveling agent, a surface control agent, a water absorbent, an anti-gelling agent, an antioxidant, a UV absorber, a light stabilizer, a plasticizer, a anti-flooding agent, an anti-coating agent, a surfactant, a defoamer, an antimicrobial agent, a mold inhibitor, preservatives, a thickener, a thermal conductivity agent, and the like.

The solvent of the releasing coating layer in view of solubility is preferably configured by acetone, tetrahydrofuran, dioxane, methylene chloride, chloroform, cyclohexane, cyclohexanone, methylethylketone, n-Hexane, diethylether, dibutylether, ethylacetate, dichloromethane, dichloroethane, pentane, ether, hexane, heptane, octane, isodecane, and the like and may be a mixture thereof.

When the seamless belt for the image forming apparatus such as a fixing belt or a transfer belt is manufactured by the releasing coating agent using the solvent, a resin or a metal may be used as the substrate.

The resin may be, for example, a heat resistance resin such as polyimide resin, polyamideimide resin, polyetheretherketone resin, polyphenylenesulfide resin, polyethersulfone resin, and the like and may be used as the substrate of the intermediate transfer belt and the fixing belt. Further, the resin may be polycarbonate, a silicon resin, a rubber resin, and the like and used as the substrate of the intermediate transfer belt. The metal may be, for example, silver, aluminum, nickel, iron, stainless steel, and the like. Further, at least one surface of the resin and the metal which is two or more-laminated may be used as the substrate.

The resin may include, for example, an electric conductive filler, a mechanical property reinforcing filler, a dye, a pigment dispersion, a solid lubricant, a sedimentation inhibitor, a leveling agent, a surface control agent, a water absorbent, an anti-gelling agent, an antioxidant, a UV absorber, a light stabilizer, a plasticizer, an anti-flooding agent, an anti-coating agent, a surfactant, an antistic agent, a defoamer, an antimicrobial agent, a mold inhibitor, preservatives, a thickener, a thermal conductivity agent, and the like.

A shape of the substrate is not particularly limited, but the substrate may be a cylindrical shape, a sheet shape, or other shapes. However, when a toner fixing belt of an electrophotographic image forming apparatus such as a facsimile, a copier, a laser beam printer, and the like is manufactured, it is preferred that the substrate is the cylindrical shape.

The method of coating the releasing coating agent on the substrate may use known methods such as a brush printing method, a spin coating method, a spray method, a dispenser method, an immersing method, an extruding method, and the like and the spray method for the intermediate transfer belt and the fixing belt is the most preferable.

A sintering process after coating may be performed at 60° C. to 200° C. The sintering process is a process performed so as to have a semipermanent release force and is not necessarily required.

A thickness of the releasing coating layer after coating or coating and sintering is preferably about 0.05 μm to 25 μm in view of a sufficient releasing expression. The thickness of the releasing coating layer is not particularly limited in the case of the fixing belt, but although t he releasing coating layer is formed as a thin film, sufficient releasing property and antifouling property are shown, such that it is preferred that the thickness is 25.0 μm or less. In the case of the intermediate transfer belt, when the thickness of the releasing coating layer is thicker, the surface resistance characteristic required in the intermediate transfer belt may be distorted, such that it is preferred that the thickness is about 0.05 μm to 3.0 μm.

It is preferred that the releasing coating layer is disposed at the outermost surface of the belt considering the releasing property with the toner.

According to the exemplary embodiment of the present invention, it is possible to provide the seamless belt with the releasing coating layer having heat resistance in which the continue use temperature is at least 350° C., the antifouling property, and excellent adhesion with the substrate and the acquired seamless belt may be useful as the intermediate transfer belt or fixing belt having the heat resistance.

### MODE FOR THE INVENTION

Hereinafter, the present disclosure will be described in detail based on Examples, but the present disclosure is not limited to Examples.

### EXAMPLE 1

A gas flow tube, a mechanical mixer, and a dewar condenser were mounted on a 4-neck flask of 300 ml and then, the inside of the flask was made at a dried nitrogen atmosphere. Outgassed pyridine of 150 ml was put into the flask, cooled in an ice tank, and then, dichlorosilane of 16 g was slowly added for 50 minutes, thereby forming a white solid adduct (SiH₂Cl₂.Py). The reaction mixture was intensely stirred in the ice tank, passed through a soda lime tube and an active carbon tube, and then, bubbled with a mixture of a pre-refined nitrogen gas and ammonia of 10.9 g for 1 hour. After completing the reaction, the solid product was centrifuged, the reaction solution was filtered, a filtrate was vacuum-dried to remove the solvent, thereby acquiring glass-type solid polysilazane of 5.52 g. A molecular weight of the polysilazane measured by a vapor pressure descent method was 1,500.

The polysilazane was dissolved in dibutylether of 5 wt %, thereby preparing a mixed solution for forming the releasing layer.

The prepared mixed solution was coated on the outer surfaces of a polyimide cylinder based on BPDA (3,3′,4,4′-biphenyl-tetracarboxylic dianhydride)-ODA (4,4′-diaminodiphenyl ether)-PPDA (paraphenylene diamine) (inner diameter of 185 mm and thickness of 65 μm) and a stainless cylinder (inner diameter of 24 mm and thickness of 0.1 mm) by a spray coating method and than, applied so as to have an average thickness of 0.2 μm after sintering at 120° C. for 20 minutes, thereby acquiring a final cylinder laminated body.

(1) Evaluation of Releasing Coating Layer

A toner(Black for CLP-300 of Samsung electronics.) used in a color laser printer was thinly scattered on the manufactured seamless belt and then, the scattered toner was removed by using a adhesive tape (Scotch magic tape of 3M Co., Ltd.). In this case, it was checked whether or not the toner remained on the seamless belt.

(2) Evaluation as Seamless Belt for Printer (Evaluation of Image Quality)

The seamless belt as the intermediate transfer belt or fixing belt of the color laser printer (CLP-300 of Samsung electronics.) was manufactured and replaced with a known fixed belt, and then quality of a print image after and before replacing was compared with the naked eye.

(3) Evaluation of Continue Use Temperature

Since the fixing belt required the continue use temperature of 250° C. or more, in the (2) evaluation as the seamless belt for printer, the manufactured seamless belt was applied to the fixing belt and then, the print image of a final printed matter was compared with that of an initial printed matter with the naked eye after printing 1000 sheets. Only the seamless belt in which the result observed with the naked eye was good was heated at 350° C. and 450° C. for 1 hour by using a furnace and then, the continue use temperature was finally evaluated by evaluating the printed matter.

The above evaluation result was represented by the following Table 1.

### EXAMPLE 2

The polysilazane synthesized by the same method as Example 1 was dissolved in cyclohexane of 1 wt %, thereby preparing a mixed solution for forming the releasing layer.

In the same method as Example 1, the mixed solution for forming the releasing layer was applied and sintered on each cylinder, thereby preparing a cylindrical laminate body having the releasing coating layer.

Accordingly, the result evaluated by the same method as Example 1 was represented by the following Table 1.

### EXAMPLE 3

A polysilazane coating solution (solid content of 0.5 wt %, molecular weight of 2000, AZEM Co., Ltd., JP) was applied and sintered on each cylinder by the same method as Example 1, thereby preparing the cylindrical laminate body having the releasing coating layer.

Accordingly, the result evaluated by the same method as Example 1 was represented by the following Table 1.

### EXAMPLES 4 TO 5

The cylindrical laminate body was prepared by the same method, except that the solid content of the mixed solution for forming the releasing layer was 10 wt % and thicknesses of the releasing coating layer were different from each other in Example 2.

Accordingly, the result evaluated by the same method as Example 1 was represented by the following Table 1.

### EXAMPLES 6 TO 9

In Example 2, the solid content of the mixed solution for forming the releasing layer was 10 wt % and the prepared mixed solution was coated on the outer surfaces of a polyimide cylinder (inner diameter of 24 mm and thickness of 65 μm) and a stainless cylinder (inner diameter of 24 mm and thickness of 0.1 mm) by a spray coating method and than, applied so as to have the thickness of 5 to 20 μm after sintering at 120° C. for 20 minutes, thereby acquiring the final cylinder laminated body.

Accordingly, the result evaluated by the same method as Example 1 was represented by the following Table 1.

TABLE 1

| | | | Thickness | | | |
|---|---|---|---|---|---|---|
| | | | of | | | |
| | | | releasing | Release property | | |
| | | | coating | of | Image | Continue use |
| | Substrate | Use | layer (μm) | toner | characteristic | temperature (° C.) |
| Example 1 | polyimide | intermediate | 0.2 | good | good | non-evaluation |
| | | transfer | | | | |
| | | belt | | | | |
| | Stainless | fixing | 0.2 | good | good | 350 or more |
| | | belt | | | | |
| Example 2 | polyimide | intermediate | 0.2 | good | good | non-evaluation |
| | | transfer | | | | |
| | | belt | | | | |
| | Stainless | fixing | 0.2 | good | good | 350 or more |
| | | belt | | | | |
| Example 3 | polyimide | intermediate | 0.2 | good | good | non-evaluation |
| | | transfer | | | | |
| | | belt | | | | |
| | Stainless | fixing | 0.2 | good | good | 350 or more |
| | | belt | | | | |
| Example 4 | polyimide | intermediate | 1.0 | good | good | non-evaluation |
| | | transfer | | | | |
| | | belt | | | | |
| | Stainless | fixing | 1.0 | good | good | 450 or more |
| | | belt | | | | |
| Example 5 | polyimide | intermediate | 3.0 | good | good | non-evaluation |
| | | transfer | | | | |
| | | belt | | | | |
| | Stainless | fixing | 3.0 | good | good | 450 or more |
| | | belt | | | | |
| Example 6 | polyimide | intermediate | 5.0 | good | good | non-evaluation |
| | | transfer | | | | |
| | | belt | | | | |
| | Stainless | fixing | 5.0 | good | good | 450 or more |
| | | belt | | | | |
| Example 7 | polyimide | intermediate | 10.0 | good | good | 450 or more |
| | | transfer | | | | |
| | | belt | | | | |
| | Stainless | fixing | 10.0 | good | good | 450 or more |
| | | belt | | | | |
| Example 8 | polyimide | intermediate | 15.0 | good | good | 450 or more |
| | | transfer | | | | |
| | | belt | | | | |
| | Stainless | fixing | 15.0 | good | good | 450 or more |
| | | belt | | | | |
| Example 9 | polyimide | intermediate | 20.0 | good | good | 450 or more |
| | | transfer | | | | |
| | | belt | | | | |
| | Stainless | fixing | 20.0 | good | good | 450 or more |
| | | belt | | | | |

In the “continue use temperature” item of Table 1, the “non-evaluation” means that the seamless belt of the polyimide substrate acquired from Examples 1 to 6 is used as the intermediate transfer belt and since the general intermediate transfer belt is used at room temperature, the evaluation becomes meaningless, such that the evaluation is not performed.

From the result of Table 1, the intermediate transfer belt or fixing belt including the releasing coating layer including the layered inorganic compound according to the exemplary embodiment of the present invention has excellent adhesion for various substrates, an excellent releasing property for toner, an excellent image characteristic, and a high continue use temperature, thereby substantially improving durability.

Simple modifications and changes and modifications of the present invention can be easily made by those skilled in the art and it can be understood that these modifications and changes are included in the scope of the present invention.

1. A seamless belt including a releasing coating layer containing a layered inorganic compound represented by the following Chemical Formula 1. 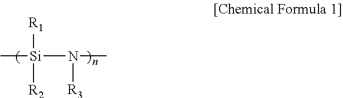
(Herein, n is an integer, R₁, R₂, and R₃ are respectively hydrogen atoms or alkyl groups, alkenyl groups, cycloalkyl groups, aryl groups, alkyl silyl groups, alkoxy groups which are C₁-C₁₈, but at least one of R₁, R₂, and R₃ is the hydrogen atom.)

2. The seamless belt of claim 1, wherein the layered inorganic compound is one or more selected from a group configured by polysilazane, silica, polysiloxane, and derivatives thereof.

3. The seamless belt of claim 1, wherein the layered inorganic compound has a molecular weight of 200 to 50000.

4. The seamless belt of claim 1, wherein the content of the layered inorganic compound is 50 to 100 wt % with respect to a weight of the releasing coating layer.

5. The seamless belt of claim 1, wherein the solvent of the releasing coating layer is formed from a solution including acetone, tetrahydrofuran, dioxane, methylene chloride, chloroform, cyclohexane, cyclohexanone, methylethylketone, n-Hexane, diethylether, dibutylether, ethylacetate, dichloromethane, dichloroethane, pentane, ether, hexane, heptane, octane, and isodecane.

6. The seamless belt of claim 1, wherein the releasing coating layer has a thickness of 0.05 to 25 μm.

7. The seamless belt of claim 1, wherein the releasing coating layer is formed at the outermost surface.

8. The seamless belt of claim 1, wherein the seamless belt is an intermediate transfer belt or fixing belt of an image forming apparatus.
